(19) United States
(12) Patent Application Publication
(10) Pub. No.: US 2002/0050093 A1
(43) Pub. Date: May 2, 2002

(54) Fishing hook

(76) Inventor: Michael A. Bahery, Medway, MA (US)

Correspondence Address: Robert J. Doherty, 11 George St., Barrington, RI, 02806, US

(21) Appl. No.: 10/012,861

(22) Filed: Oct. 22, 2001

Related U.S. Application Data
(60) Provisional application No. 60/243,334, filed on Oct. 27, 2000.

(51) Int. Cl. A01K 83/00

(52) U.S. Cl. 43/43.16

(57) ABSTRACT

An improved fish hook having multiple barbs utilized in conjunction with a penetrating point of a hook portion of a fishing hook and which barbs are longitudinally spaced from each other so as to more securely attach the fish to the line once the fish has been initially hooked and in that way increase the secure attachment. The improved hook configuration is particularly useful for recreational and survival fishing activities.

### BACKGROUND AND OBJECTS OF THE INVENTION

One of the recurring problems in recreational or even survival fishing is that once a fish is hooked by a conventional hook having a point and adjacent barb, the fish can often wiggle free and dislodge the embedded hook at any number of points along the path or process of landing the fish to a secure location. Conventional fishing hooks include a shank, which terminates at one end in an eyelet that defines an opening through which fishing line can be threaded to securely attach the hook. Such shank terminates at its other end in a hook portion connected to the shank by means of a curved connector throat. The hook portion in turn terminates in a sharpened point which serves to penetrate the skin or internal skin flesh areas of the fish generally around its mouth and in some cases even external body portions depending upon how the hook is baited and how the fish attacks such. Immediately adjacent the penetrating point is an outwardly extending barb—the purpose of which is to prevent the rearward movement of the hook vis-A-vis the fish and thus retain the hook in the fish during the landing process and until purposely removed by the fisherman. Such barb, however, often fails to serve the aforementioned purpose and becomes loose through the fish's struggle or otherwise is forced through the opening initially formed by the penetrating point on impact or otherwise tears flesh away so that the hook becomes dislodged and the fish is lost.

Accordingly, the primary object of the present invention is to provide a hook configured such that it is more difficult for the fish to be removed therefrom either during the catching or struggling process so that once hooked, there is a high relative degree of surety of being able to land the fish. This is particularly important in recreational and survival type fishing.

Another object of the present invention is to provide for the aforementioned results in such a way that the force needed to penetrate the fish's body is not materially increased such that the fishing process is otherwise unaltered.

These and other objects are accomplished by a fish hook comprising a shank, a point portion and a curved connecting portion connecting said point and shank portions, said shank including an eyelet for connecting the hook to a fish line, said point portion terminating in a sharp fish penetrating point, a first outwardly extending barb positioned on said point portion immediately adjacent said penetrating point and a second outwardly extending barb positioned on said point portion at a location rearwardly longitudinally spaced from said first barb.

Other objects, features and advantages of the invention shall become apparent as the description thereof proceeds when considered in connection with the accompanying illustrative drawings.

### DESCRIPTION OF THE DRAWINGS

In the drawings which illustrate the best mode presently contemplated for carrying out the present invention:

FIG. 1 is an elevational view showing a conventional prior art fishing hook;

FIG. 2 is an elevational view showing one form of the novel fishing hook of the present invention;

FIG. 3 is a right side elevational view of FIG. 2;

FIG. 4 is a further embodiment of the fishing hook of the present invention showing another form that such may take;

FIG. 4A is a further modified form of the fishing hook of the present invention similar to the form shown in FIG. 4 but with the lower barb displaced out of the plane of the penetrating point and the first barb; and

FIG. 5 is a side elevational view of a still further form that the present invention may take.

### DESCRIPTION OF THE PREFERRED EMBODIMENT

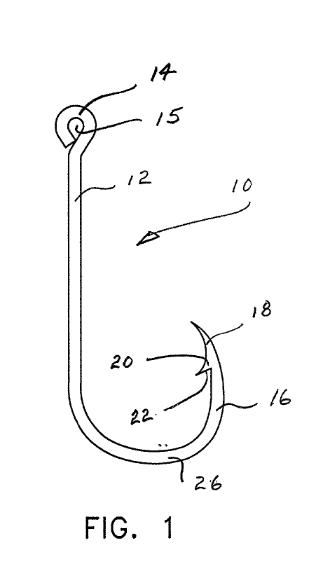

Referring to the drawings and particularly FIG. 1, a conventional fishing hook 10 is depicted as having a shank portion 12 which in turn terminates at one end in an eyelet 14 defining an opening 15 therethrough such that fishing line (not shown) may be attached thereto. The other end of the hook terminates in a hook portion 16 terminating in a sharpened point 18 that includes a rearwardly outwardly extending barb 20 as an integral portion thereof. The barb 20 includes an inset or reversed curved portion or shelf 22 such that once the hook pierces or penetrates through the skin or flesh of the fish, the shelf 22 tends to retain such position if the hook is pulled in the reverse position especially when the hook is twisted after penetration of the skin or flesh.

A curved connection throat 26 serves to connect the hook portion with the shank. It should also be pointed out that it is conventional to slightly inwardly curve the hook portion so that it extends somewhat closer to the shank portion at its penetrating tip than at its lower portion connected to the connector throat although such to a great extent is dependent upon the fishing activity envisioned. Generally, conventional fish hooks such as fish hook 10 depicted and fish hooks constructed in accordance with the present invention as will hereinafter be more fully explained are formed from thin circular metal stock such as varieties of rust resistant steel which is then bent and stamped or otherwise formed by progressive measures into the final configuration of the hook desired. Obviously, materials other than metal may be utilized such as plastic and the like and, accordingly, could be injection molded.

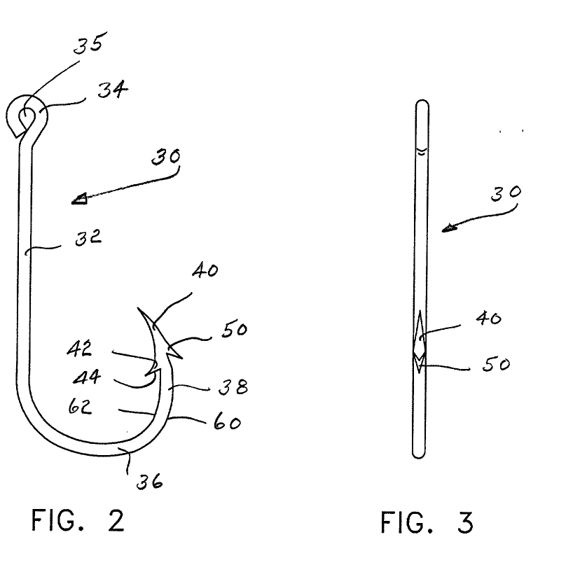

Turning now to the remainder of the drawings and particularly at least initially to FIGS. 2 and 3, one form of a fishing hook constructed in accordance with the present invention is depicted. Such hook 30 includes a shank 32 which at one end thereof terminates in an eyelet 34 which defines an opening 35 through which fishing line is threaded to attach the hook 30. Such eyelet connection configuration is the preferred form of attaching fishing line to the fishing hook although other alternate mechanisms can be utilized, and that portion of the hook structure is not a critical aspect of the invention so long as attachment in a secure manner is achieved.

The shank 32 extends downwardly from the eyelet to a curved connector portion 36 which then upwardly extends so as to form a hook portion 38 which in turn terminates in a penetrating point 40 including a first outwardly rearwardly extending barb 42 also exhibiting a stop or shelf 44. In addition to such structure, the present hook includes a second barb 50 located at a position longitudinally upwardly spaced from the first barb 42 and in the case of the embodiment shown in FIGS. 2 and 3, positioned on the outer side of the hook portion. It should be pointed out the hook portion can be defined as including a outer or distal surface 60 which faces away from the shank and an inner or proximal surface 62 which faces towards the shank.

The presence of the two barbs 42 and 50 and their position longitudinally spaced from each other serves to more securely capture the fish once the penetrating point 40 punctures the skin or flesh of the fish and the hook is embedded therein. It should also be noted that the outward extent or flare of both of the barbs 42 and 50 is approximately the same, that is, their lateral extent away from the body of the hook portion itself is approximately equal so that the degree of force needed to penetrate the fish's body is not increased but that the force necessary to remove a fish once hooked is substantially increased and thus provides for a more secure attachment thus assuring the objects of the present invention.

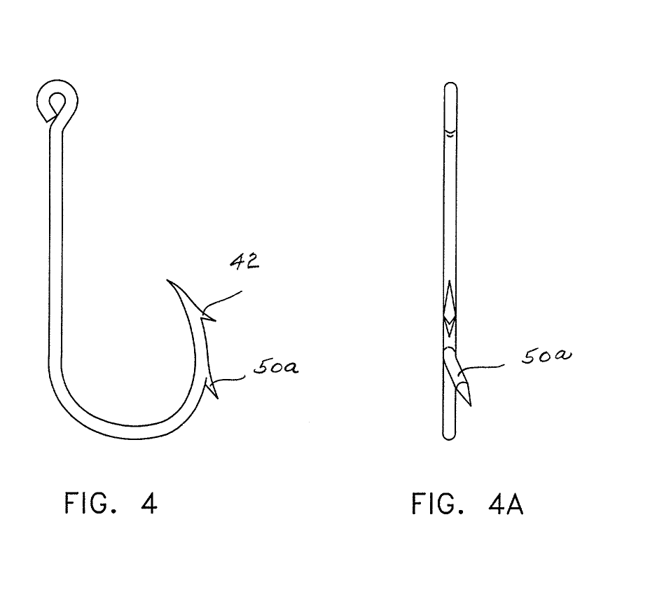

Turning now to FIG. 4, a further embodiment of the invention is depicted in which the second bard 50a is positioned longitudinally spaced from the first barb 42 downwardly along the body of the hook portion but on the same distal surface thereof as is the initial barb 42. Again the outward extent and thickness of the barb 50a approximates that of barb 42 and accomplishes generally the same result as that depicted in the FIGS. 2 and 3 configurations although it should be pointed out that having the second barb positioned on the surface opposite the first barb in some cases achieves a more secure attachment of the fish hook to the fish in that a greater area of the fish's skin or flesh must be pulled away in order to dislodge the embedded hook from the fish, that is, the return opening hole may be smaller in the case of barbs affixed to one side of the hook portion only assuming, of course, that the hook is pulled straight out in the same direction that it was forced in.

FIG. 4A shows an alternate second barb construction that is outwardly flared from the plane of the penetrating point and first barb so as to, in effect, create a more complex puncture configuration, that is, L-shaped, as contrasted to a straight line generally caused by the FIG. 4 alternative.

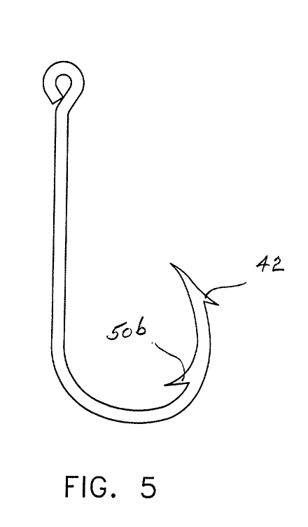

Turning now to FIG. 5 of the drawing, a still further embodiment of the invention is shown in which the secondary hook 50b is shown in a position significantly longitudinally downwardly spaced from the initial barb 42 and, as in the case of the FIGS. 2 and 3 embodiment, positioned on the inside or proximal surface of the hook portion.

In all the embodiments, it should be pointed out that the multiple barbs are positioned on the hook portion of the hook rather than on the shank portion in which regard it is common to provide a barb or at least roughened areas in order to secure bait thereon but not for the purpose of the present invention to more securely embed the fishing hook into the fish once the fish is caught to make it more able to be securely retrieved by the fisherman.

While each of the above-described embodiments utilizes two barbs, a primary barb and secondary barb, it should be pointed out that further additional secondary barbs can be utilized in some cases, for instance, a tertiary barb similar to barb 50a of FIG. 4 could be positioned in the same general area but on the hook shown in FIG. 2 or similarly the secondary barb 50 shown in FIG. 2 could also be utilized in conjunction with the hook configuration shown in FIG. 5. The important feature being that at least two barbs, which are longitudinally spaced from each other along the hook portion of the hook, are utilized.

While there is shown and described herein certain specific structure embodying this invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A fish hook comprising a shank, a point portion and a curved connecting portion connecting said point and shank portions, said shank including an eyelet for connecting the hook to a fish line, said point portion terminating in a sharp fish penetrating point, a first outwardly extending barb positioned on said point portion immediately adjacent said penetrating point and a second outwardly extending barb positioned on said point portion at a location rearwardly longitudinally spaced from said first barb.

2. The fish hook of claim 1, wherein said point portion has an inner side facing at least a portion of said shank and an outer side facing away from said shank and wherein both said barbs are positioned on said point portion outer side.

3. The fish hook of claim 1, wherein said point portion has an inner side facing at least a portion of said shank and an outer side facing away from said shank and wherein said first barb is position on said point portion outer side and said second barb is positioned on said point portion inner side.
